(19) United States
(12) Patent Application Publication
(10) Pub. No.: US 2016/0324140 A1
(43) Pub. Date: Nov. 10, 2016

(54) GAME ANIMAL DISTRACTION APPARATUS

(71) Applicant: Twin Ports Products LLC, Minneapolis, MN (US)

(72) Inventor: Joe Gregorich, Duluth, MN (US)

(21) Appl. No.: 15/147,384

(22) Filed: May 5, 2016

Related U.S. Application Data
(60) Provisional application No. 62/157,150, filed on May 5, 2015.

(51) Int. Cl. A01M 31/00; A45F 3/14; H04R 1/32; A01M 31/06; H04R 1/02

(52) U.S. Cl. CPC A01M 31/004; A01M 31/06; H04R 1/025; H04R 1/323; A45F 3/14

(57) ABSTRACT

A game animal distraction apparatus comprised of an electronic transmitter and a receiver/speaker. More specifically, the electronic transmitter is attached to or near a hunter and has a front and back housing, a switch, a transmitter button, a cable, a circuit board, and a power source. The receiver/speaker is attached to a tree or other vertical surface and has a front and back housing, a circuit board, a speaker, a connection point for receiving a connector such as a strap, a speaker projection, and a power source. The game animal distraction apparatus can be used to emit a noise, which can distract game animal and better orient the game animal for hunters.

### CROSS-REFERENCE TO RELATED APPLICATION

This application claims the benefit of U.S. Provisional Application No. 62/157,150, filed May 5, 2015, titled GAME ANIMAL DISTRACTION APPARATUS AND METHOD.

### FIELD OF THE DISCLOSURE

The present disclosure relates to a remotely activated audio generation apparatus that, when activated, distracts and better orients a game animal for a hunter.

### BACKGROUND OF THE INVENTION

Hunting is a popular outdoor recreational activity, whether with a firearm or a bow. Hunting with firearms has traditionally been an easier way for hunters to kill an animal, because hunters can rely on a more powerful weapon that has a long shot range and more precise aiming mechanics. Hunters who prefer to use a bow and arrow face a number of challenges. For example, to obtain a possible kill shot, the game animal must be closer in range and be properly positioned. Further, the hunter must, more so than with firearms, avoid detection. These challenges lead to fewer opportunities for kill shots and, therefore can cause hunters to wound animals instead of killing them cleanly or instantly. Therefore, a device is needed that allows bow hunters to gain greater proximity to a game animal and that increases the likelihood of a clean kill shot.

### SUMMARY OF THE INVENTION

The disclosed system is an electronic transmitter and receiver/speaker to be used by hunters to distract and better position game for a “clean kill” shot. More specifically, the system is comprised of a transmitter and a receiver/speaker, wherein the transmitter is located on or near the hunter and the receiver/speaker is located on a tree or other vertical surface within both transmission range and audible distance of the transmitter. When the hunter activates the transmitter, the receiver/speaker can produce a sound that will help stop and better orient the game for a successful hunting outcome.

### BRIEF DESCRIPTION OF THE DRAWINGS

FIG. 1 is an exploded view of one embodiment of the disclosed receiver/speaker.

FIG. 2 is a front perspective view of one embodiment of the disclosed receiver/speaker.

FIG. 3 is a back perspective view of one embodiment of the disclosed receiver/speaker.

FIG. 4 is a front view of one embodiment of the disclosed receiver/speaker.

FIG. 5 is a side view of one embodiment of the disclosed receiver/speaker.

FIG. 6 is a back perspective view of one embodiment of the disclosed receiver/speaker.

FIG. 7 is a front perspective view of one embodiment of the disclosed receiver/speaker.

FIG. 8 is a top view of one embodiment of the disclosed receiver/speaker.

FIG. 9 is a front view of one embodiment of the disclosed receiver/speaker.

FIG. 10 is a side view of one embodiment of the disclosed receiver/speaker.

FIG. 11 is a top view of one embodiment of the disclosed receiver/speaker.

FIG. 12 is a front view of one embodiment of the disclosed receiver/speaker.

FIG. 13 is a side view of one embodiment of the disclosed receiver/speaker.

FIG. 14 is a top view of one embodiment of the disclosed transmitter.

FIG. 15 is a front view of one embodiment of the disclosed transmitter.

FIG. 16 is a side view of one embodiment of the disclosed transmitter.

FIG. 17 is a top view of one embodiment of the disclosed transmitter.

FIG. 18 is a front view of one embodiment of the disclosed transmitter.

FIG. 19 is a side view of one embodiment of the disclosed transmitter.

FIG. 20 is a bottom view of one embodiment of the disclosed transmitter.

FIG. 21 is a front view of one embodiment of the disclosed transmitter.

FIG. 22 is a side view of one embodiment of the disclosed transmitter.

FIG. 23 is a bottom view of one embodiment of the disclosed transmitter.

FIG. 24 is a front view of one embodiment of the disclosed transmitter.

FIG. 25 is a side view of one embodiment of the disclosed transmitter.

FIG. 26 is a top view of one embodiment of the disclosed receiver/speaker.

FIG. 27 is a bottom view of one embodiment of the disclosed receiver/speaker.

FIG. 28 is a side view of one embodiment of the disclosed receiver/speaker.

FIG. 29 is a front view of one embodiment of the disclosed receiver/speaker.

FIG. 30 is a bottom cross-sectional view of one embodiment of the disclosed receiver/speaker.

FIG. 31 is a side cross-sectional view of one embodiment of the disclosed receiver/speaker.

FIG. 32 is a side view of one embodiment of the disclosed receiver/speaker.

FIG. 33 is a back view of one embodiment of the disclosed receiver/speaker.

FIG. 34 is a front perspective view of one embodiment of the disclosed receiver/speaker.

FIG. 35 is a front perspective view of one embodiment of the disclosed transmitter.

FIG. 36 is a back perspective view of one embodiment of the disclosed transmitter.

FIG. 37 is a cross sectional view of one embodiment of the disclosed transmitter taken from line 37-37 in FIG. 40.

FIG. 38 is a top view of one embodiment of the disclosed transmitter.

FIG. 39 is a side view of one embodiment of the disclosed transmitter.

FIG. 40 is a front view of one embodiment of the disclosed transmitter.

FIG. 41 is a side view of one embodiment of the disclosed transmitter.

FIG. 42 is a cross sectional view of one embodiment of the disclosed transmitter taken from line 42-42 in FIG. 40.

FIG. 43 is a bottom view of one embodiment of the disclosed transmitter.

FIG. 44 is a cross sectional view of one embodiment of the disclosed transmitter taken from line 44-44 in FIG. 40.

FIG. 45 is a back view of one embodiment of the disclosed transmitter.

FIG. 46 is a cross sectional view of one embodiment of the disclosed transmitter taken from line 46-46 in FIG. 45.

FIG. 47 is a side view of one embodiment of the disclosed transmitter.

FIG. 48 is a front view of one embodiment of the disclosed transmitter.

FIG. 49 is a side view of one embodiment of the disclosed transmitter.

FIG. 50 is a top view of one embodiment of the disclosed transmitter.

FIG. 51 is a bottom view of one embodiment of the disclosed transmitter.

FIG. 52 is a front view of one embodiment of the disclosed transmitter.

FIG. 53 is a cross sectional view of one embodiment of the disclosed transmitter taken from line 53-53 in FIG. 52.

FIG. 54 illustrates one embodiment of the disclosed system.

FIG. 55 is a system level diagram illustrating how the transmitter and receiver/speaker communicate.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

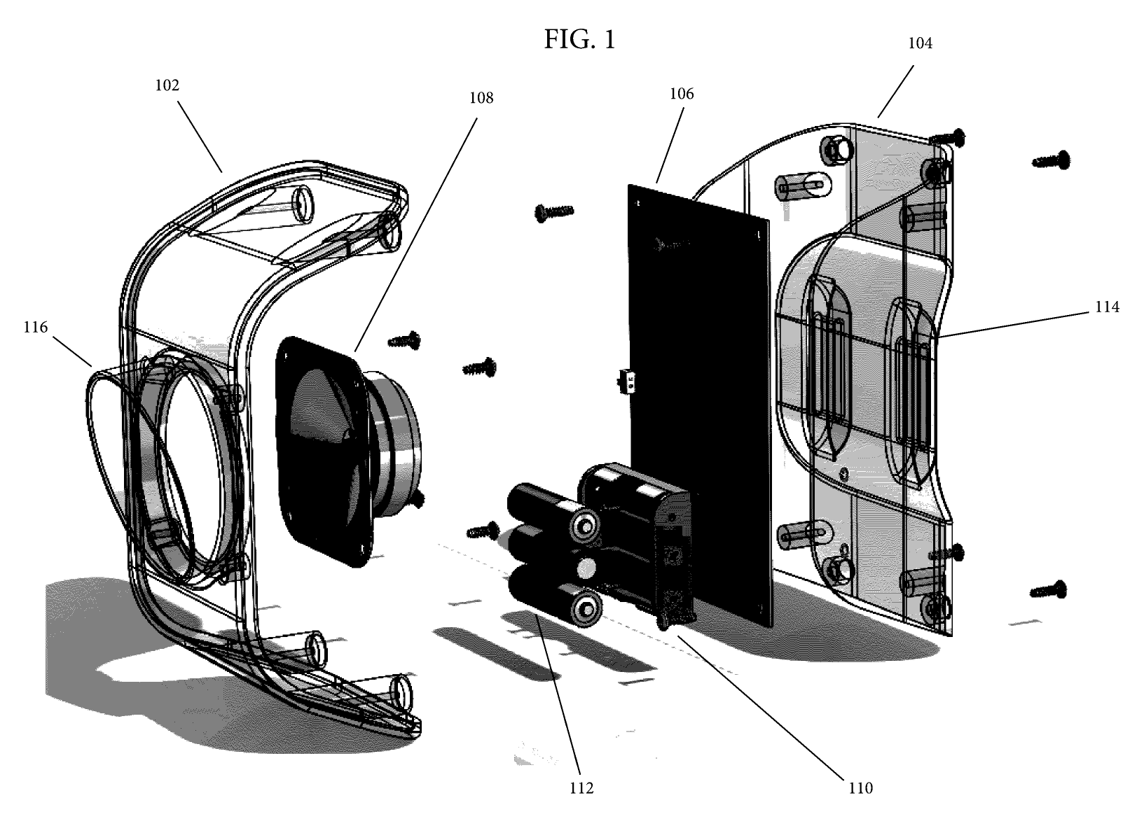

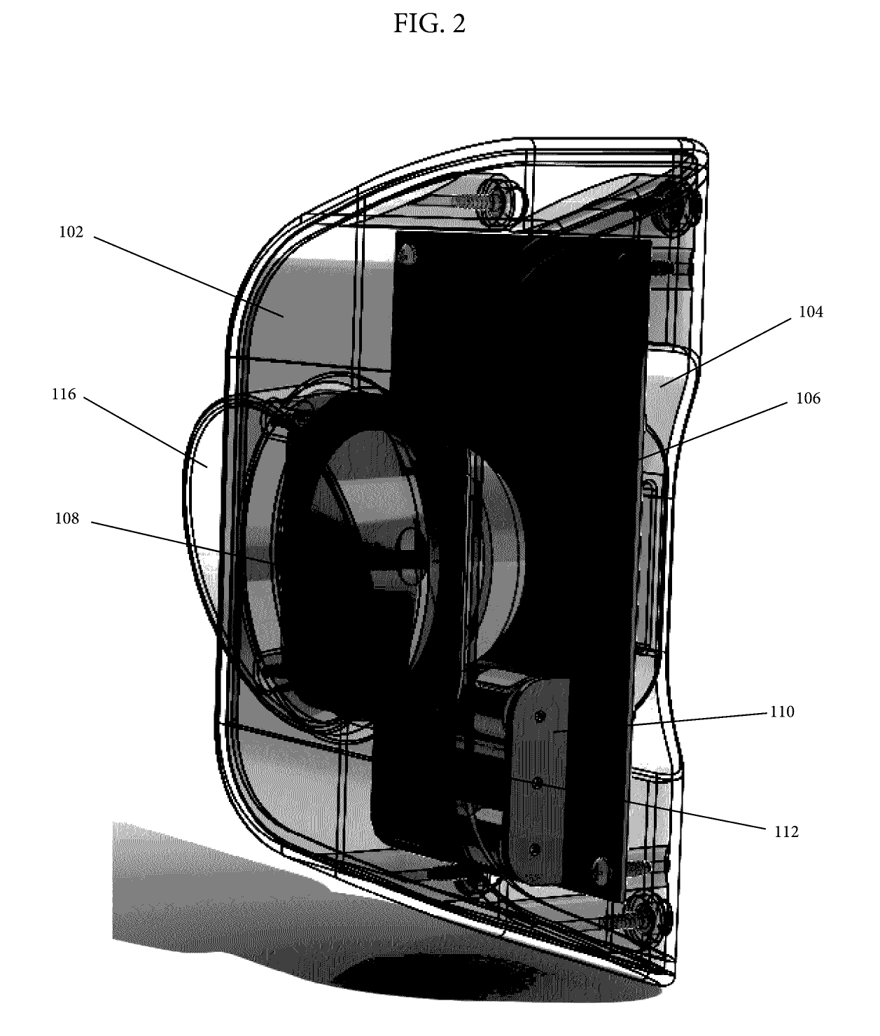

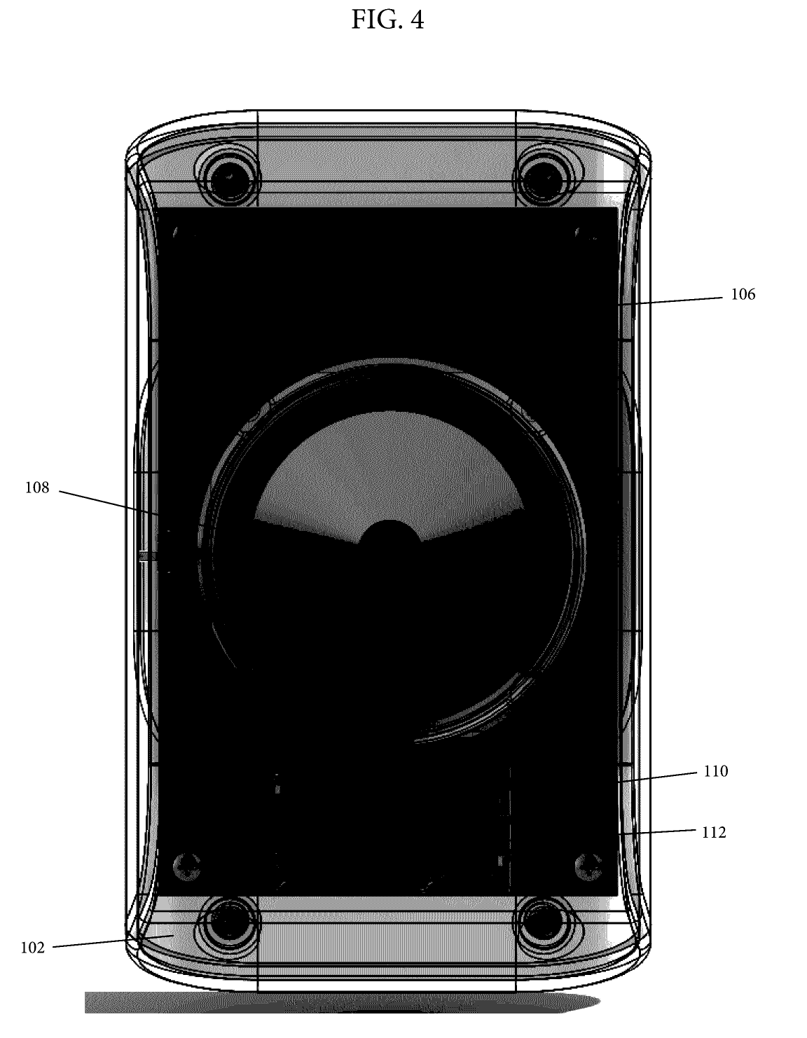

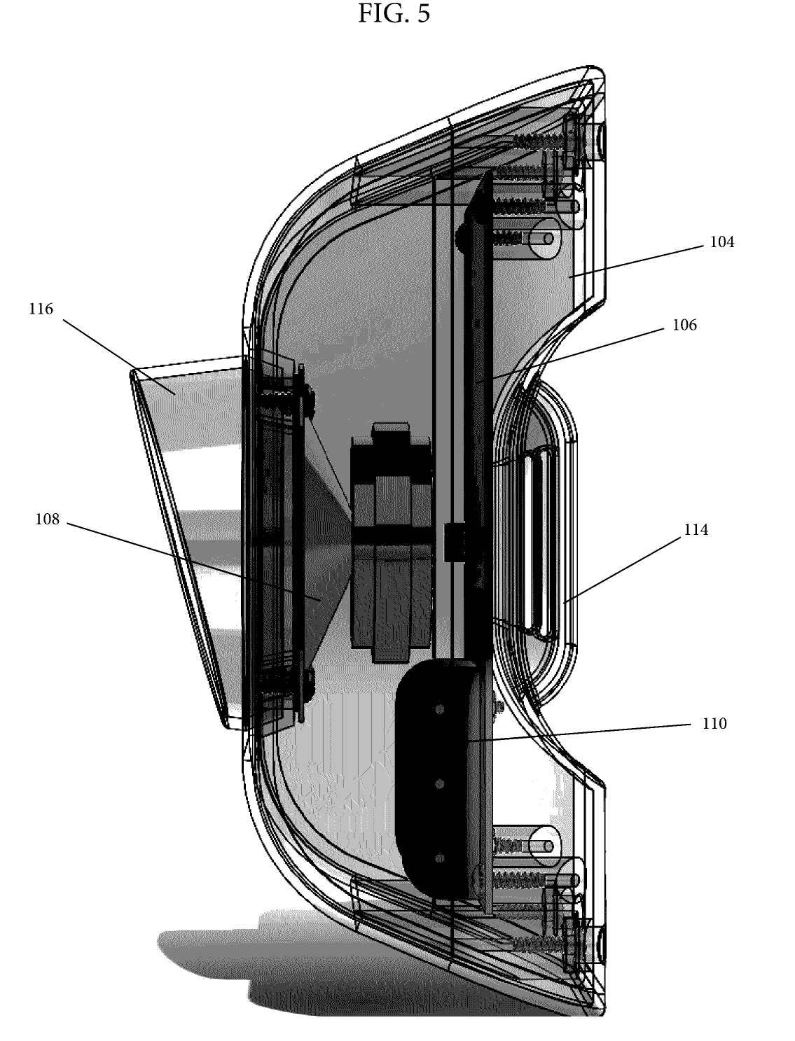

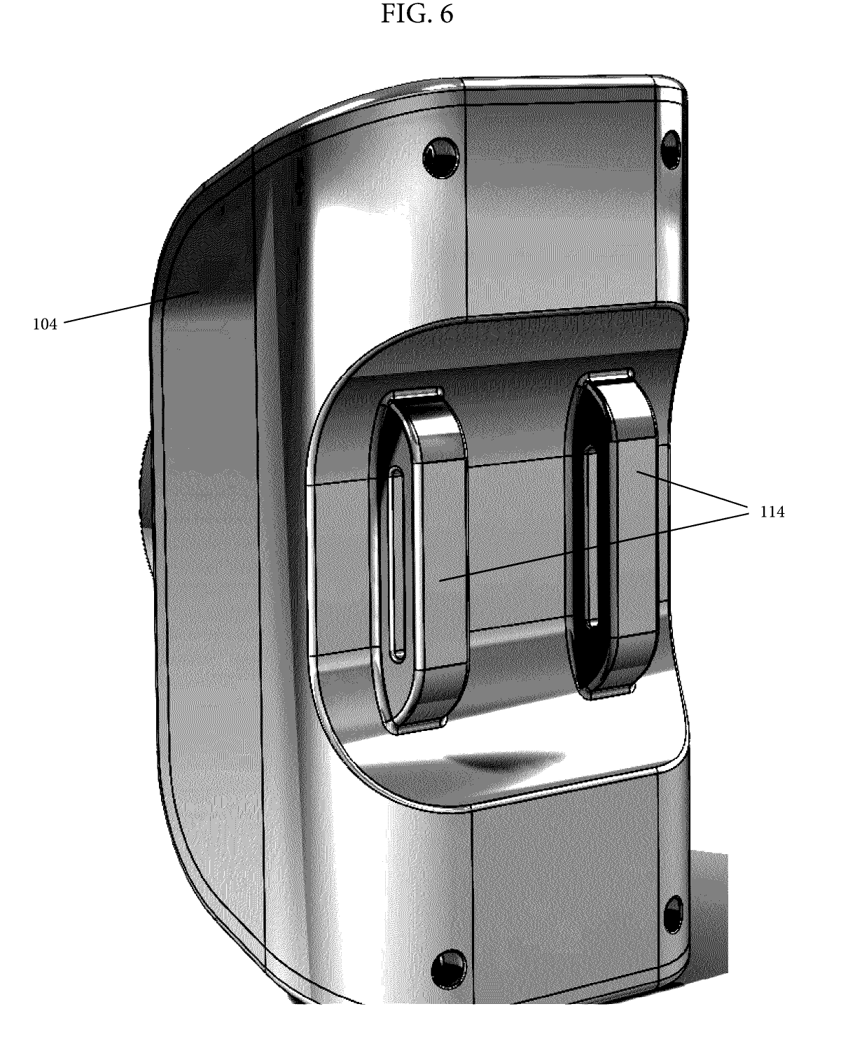

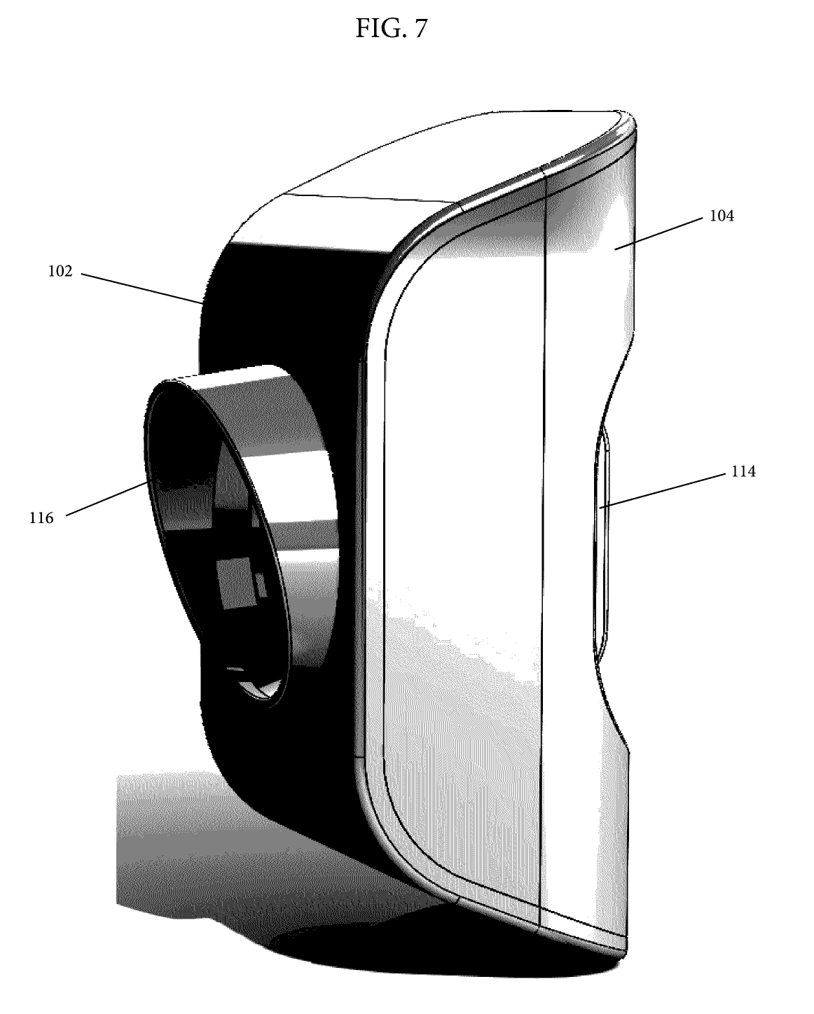

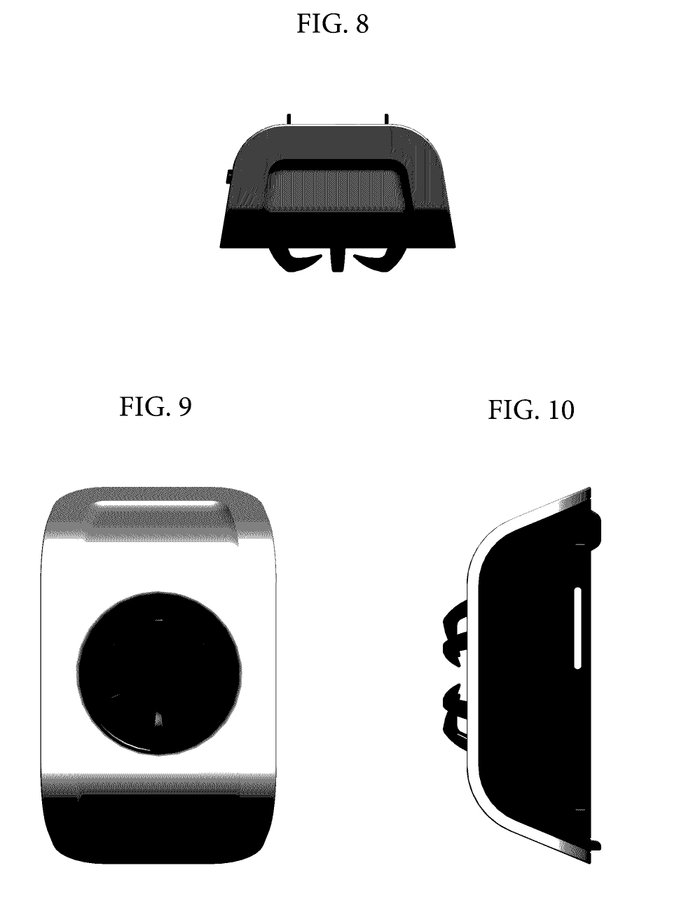

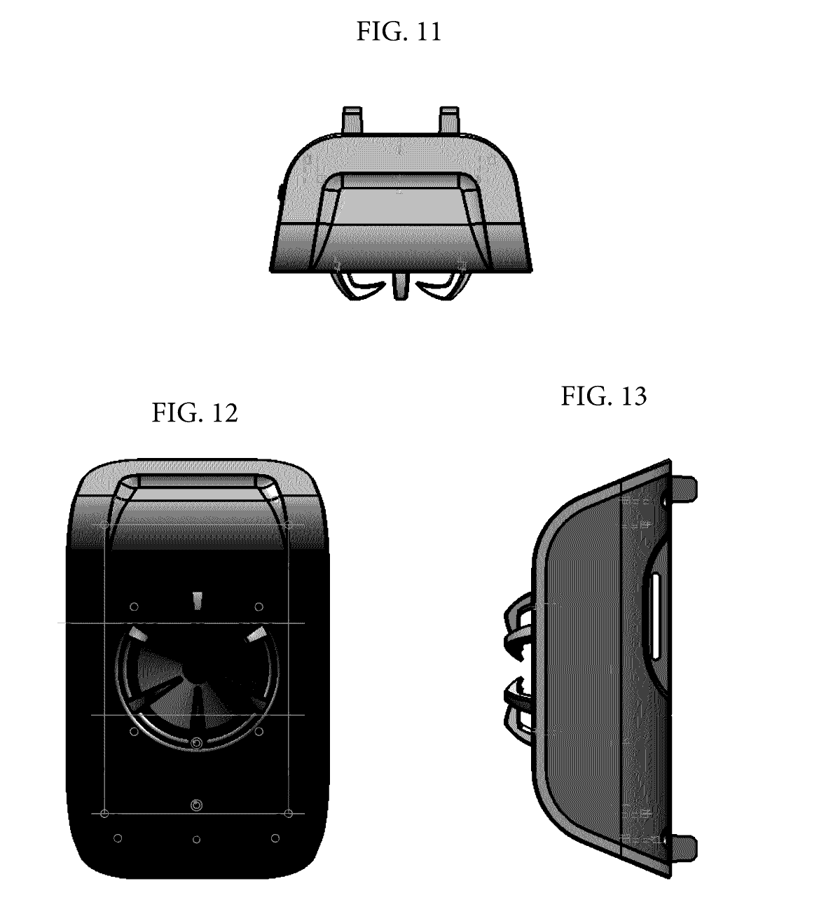

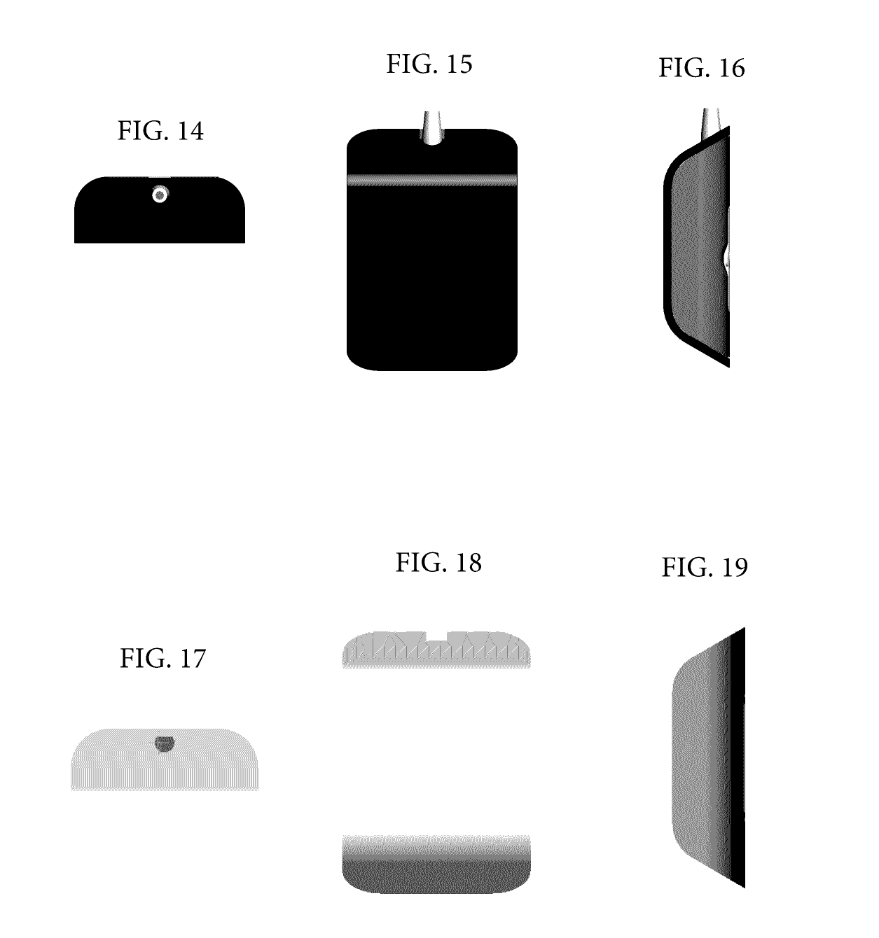

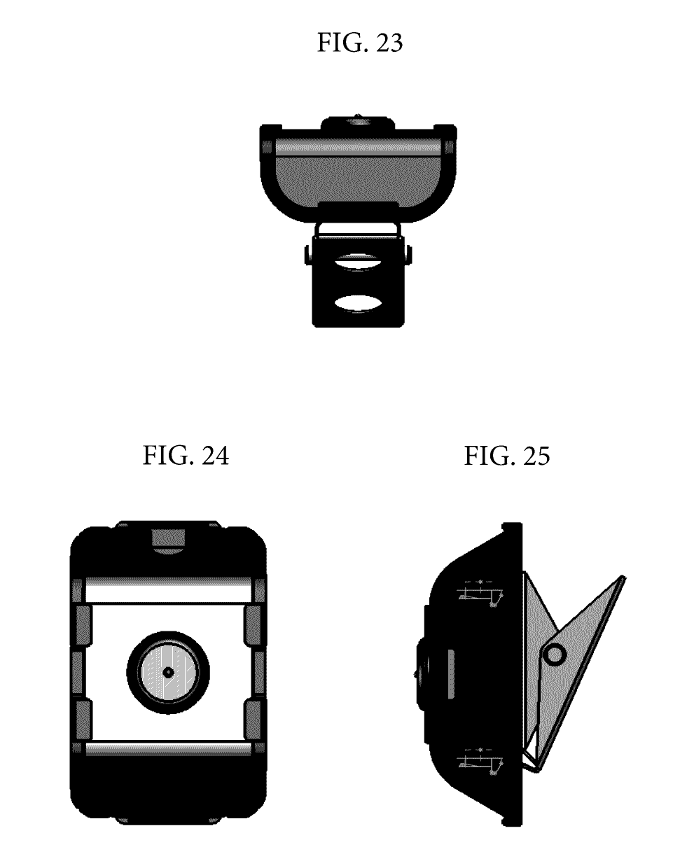

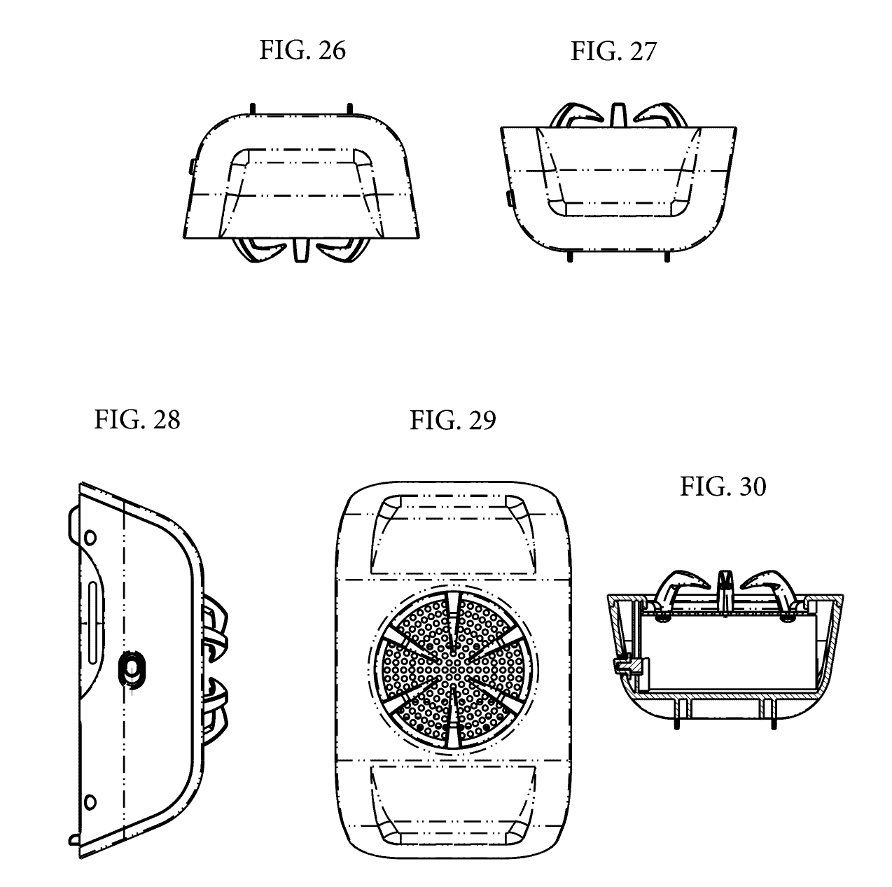

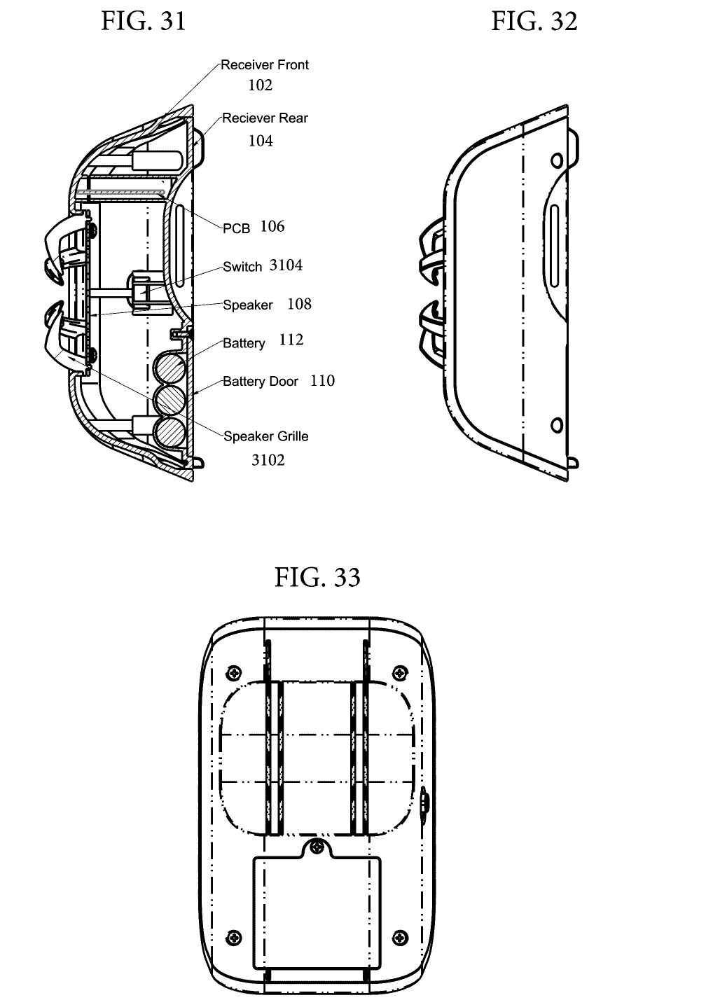

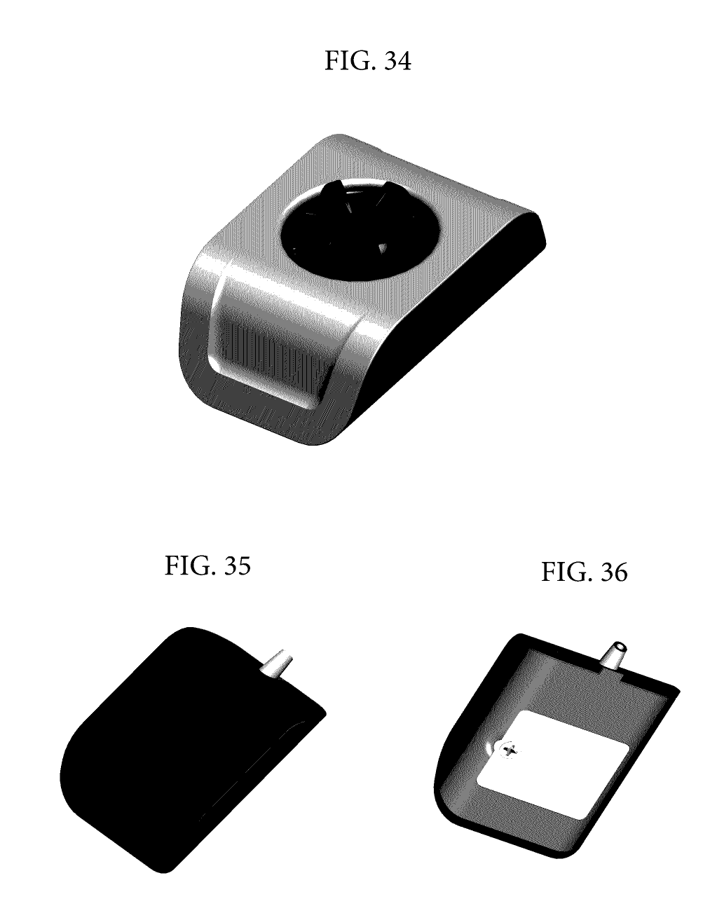

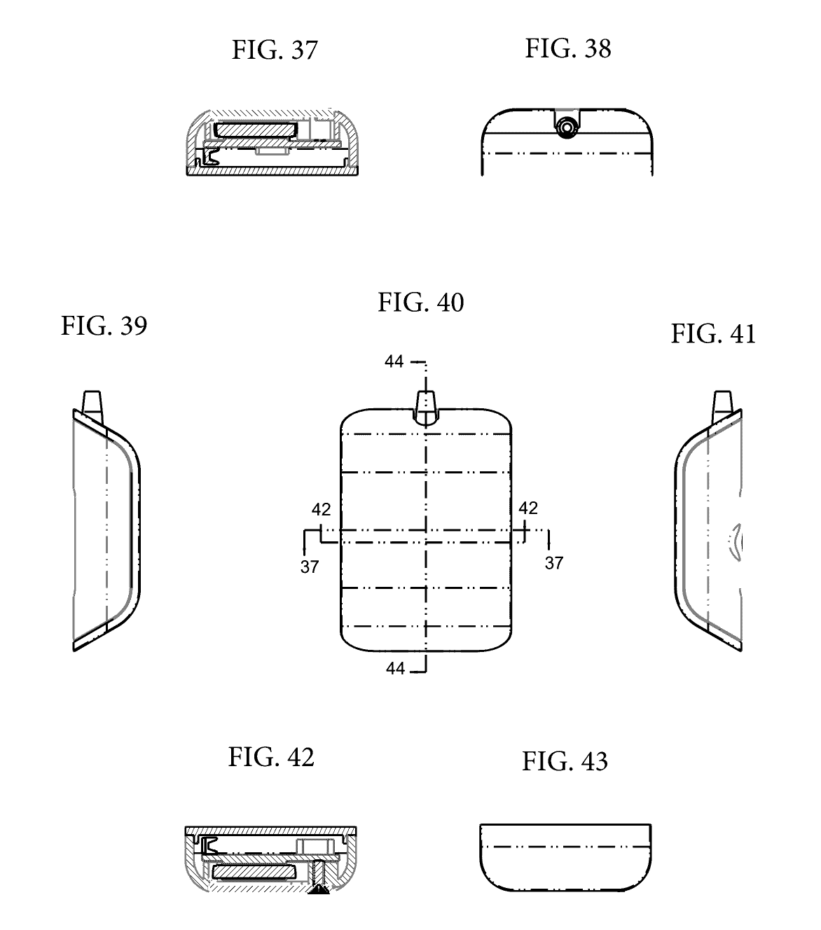

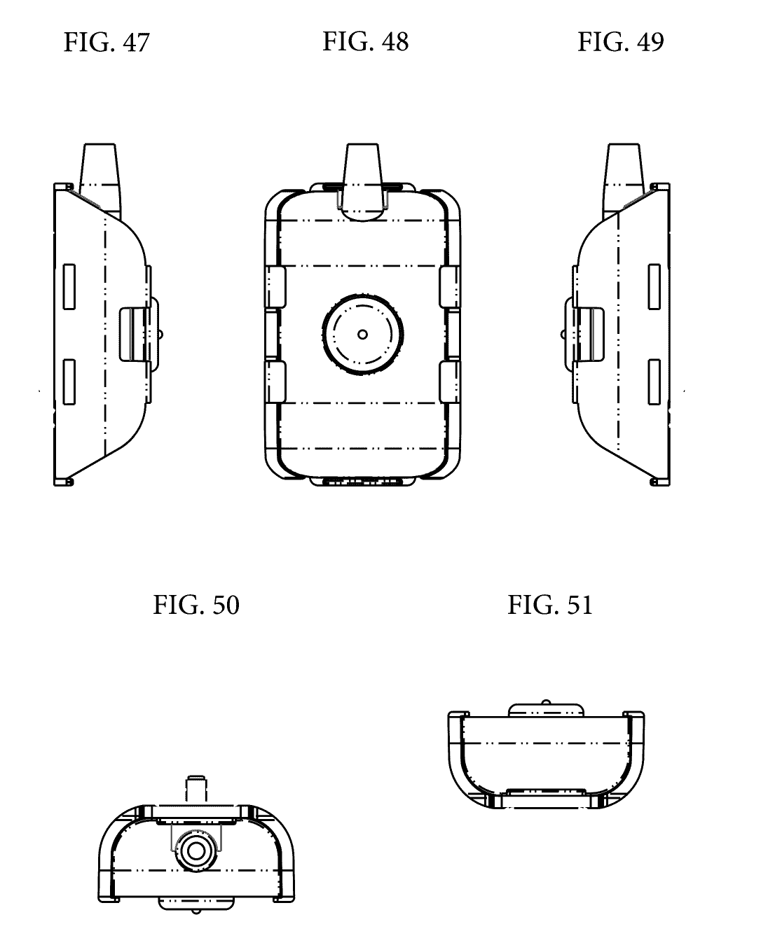

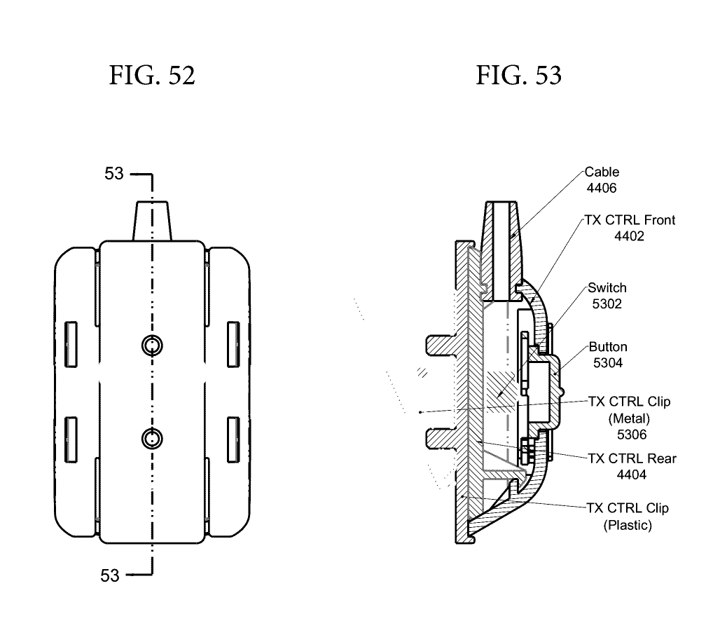

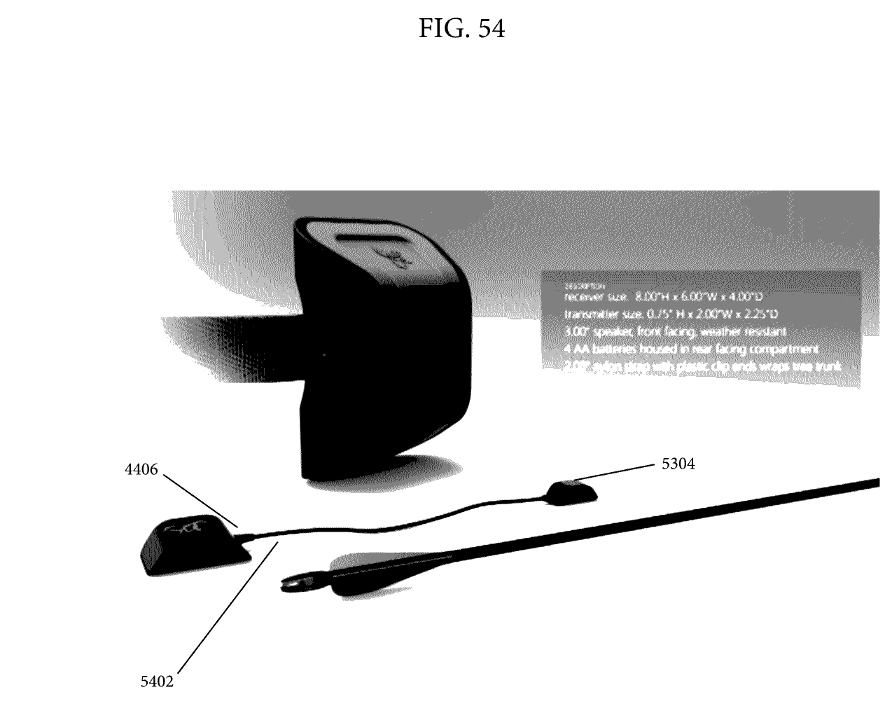

The disclosed system, illustrated in FIG. 54, is an electronic transmitter and receiver/speaker to be used by hunters to distract and better position game for a “clean kill” shot. More specifically, the system is comprised of a transmitter, illustrated in FIGS. 14-25 and 35-53, and a receiver/speaker, illustrated in FIGS. 1-13 and 26-34, wherein the transmitter is located on or near the user and the receiver/speaker is located on a tree or other vertical surface within both transmission range and audible distance of the transmitter.

As illustrated in FIG. 1, the receiver/speaker can be comprised of a trapezoidal or rectangular receiver front housing 102 with top, front, and bottom portions; a receiver back housing 104 with left, right, and back portions; a circuit board 106; a speaker 108 facing outward through a circular hole in the front portion of the receiver front housing 102; a power source enclosure (for example, a battery door) 110 that holds a power source (for example, a plurality of batteries) 112; at least one connection point (for example, a strap opening) 114 for receiving a connector such as a strap; and a speaker projection 116 that can direct sound from the speaker 108 and protect the speaker 108 from various weather elements such as rain, snow, sleet, sun, and wind. In some embodiments, a speaker grille 3102 can replace, or be used in combination with, the speaker projection 116. In some embodiments, the receiver/speaker has an on/off switch 3104. The receiver front housing 102 and receiver back housing 104 can act as a housing and contain most or all of the other components of the receiver/speaker.

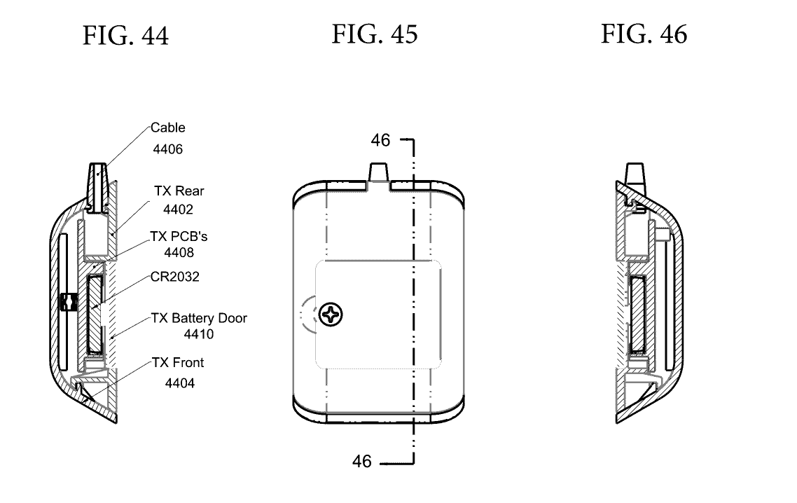

As illustrated in FIGS. 44 and 53, the transmitter can be comprised of a trapezoidal or rectangular transmitter front housing 4402; a transmitter back housing 4404; a switch 5302; a transmitter button 5304 on the transmitter front housing 4402; a cable 4406; a circuit board 4408; and a power source enclosure (for example, a battery door) 4410 that holds a power source. In some embodiments, as illustrated in FIG. 54, the transmitter button 5304 can be located at the end of a cable wire 5402 that attaches to the cable 4406 instead of directly attached to the transmitter front housing 4402. In some embodiments, the transmitter front housing 4402 and transmitter back housing 4404 can act as a housing and contain most or all of the other components of the transmitter. In some embodiments, a clip 5306 can be attached to the transmitter back housing 4402 to enable the user to clip the transmitter to a bow or article of clothing.

When the user activates the transmitter, the receiver/speaker can produce a sound. In a preferred embodiment, a user will activate the transmitter when game animal is nearby, and the sound produced by the receiver/speaker will help stop and better orient the game for a successful hunting outcome. The sound can be of a twig or branch breaking and can be produced at various volume levels. Other sounds are also possible. In one embodiment, a data storage module contained on the device provides one or more sound files that are loaded and rendered through the on-board speaker.

The device could also be configured to generate new digital sound signals in real time based on instructions sent to a sound chip. In one embodiment, a microcontroller is loaded with MIDI sound data files that are delivered to a standard horn speaker or to one or more other driver designs such as, but not limited to, piezoelectric speakers, magnetostatic loudspeakers, magnetostrictive speakers, electrostatic loudspeakers, and electrodynamic speakers.

Further, the device could be designed to allow for user modification of the sound library, whether through a removable memory card, USB port, or wireless data connection, or through recording of audio.

In some embodiments, the transmitter is attached to the bow, but is unobtrusive to the bow by being small and lightweight. In some embodiments, the transmitter is attached to the user. It can have a cord with a single small button that can be attached near the user's finger. In some embodiments, the cord is six to seven inches long.

The button can be approximately 1¼ inches tall, ¾ inches wide, and ½ inch deep. The button assembly can include a button (ex: a rounded button) with a two-conductor cable to the transmitter assembly coming out of the side or bottom. Additionally, it can be mounted on a hook and loop pad.

The transmitter can be approximately 2¼ inches tall, 1½ inches wide, and ½ deep. The transmitter can hold the electronics and can be mounted to the bow or the user using a hook and loop attachment system. It can include a button (ex: a rounded button) stacked vertically, wherein the wire to the transmitter assembly exits from the side of the transmitter.

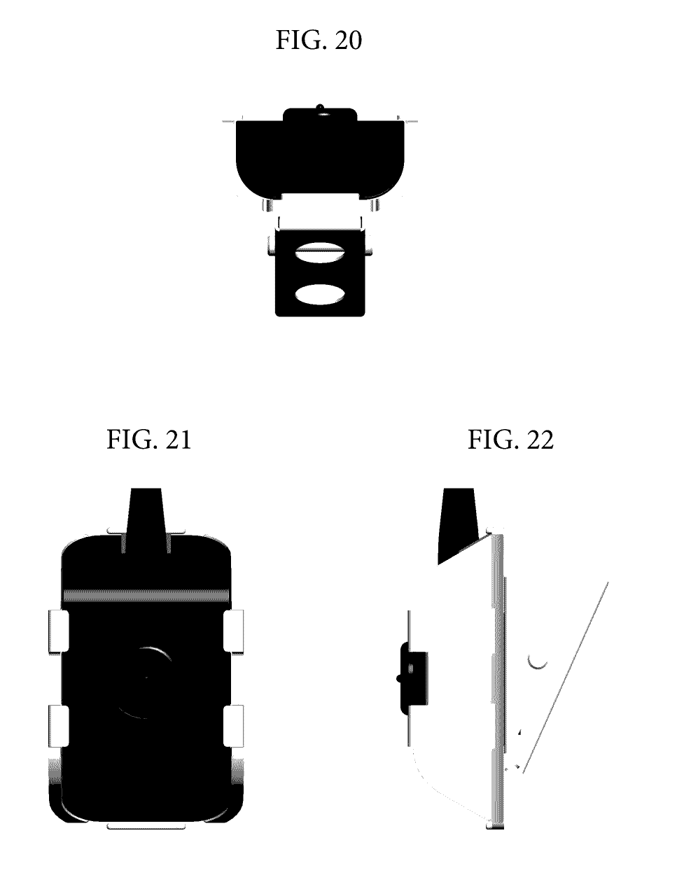

The transmitter can be located on various spots on the bow or the user and can be easily attachable and secured. For example, the transmitter may connect to a strap, bow, or other object through the use of a clip, as illustrated in FIGS. 20, 22, 23, 25, 47, and 49-53, double sided adhesive, or hook and loop. The use of hook and loop can allow the transmitter to be easily moved between locations, such as between two bows, between a bow and a user, or between any other objects on or near the user.

In some embodiments, the receiver/speaker has a low profile and is capable of being easily tied, hooked, or mounted onto a tree or other vertical surface. For example, the receiver can be seven to eight inches tall, three to four inches wide, and two to four inches deep. The speaker could be two to three inches tall. The receiver can also be black or brown in color so as not to stand out in a woods setting.

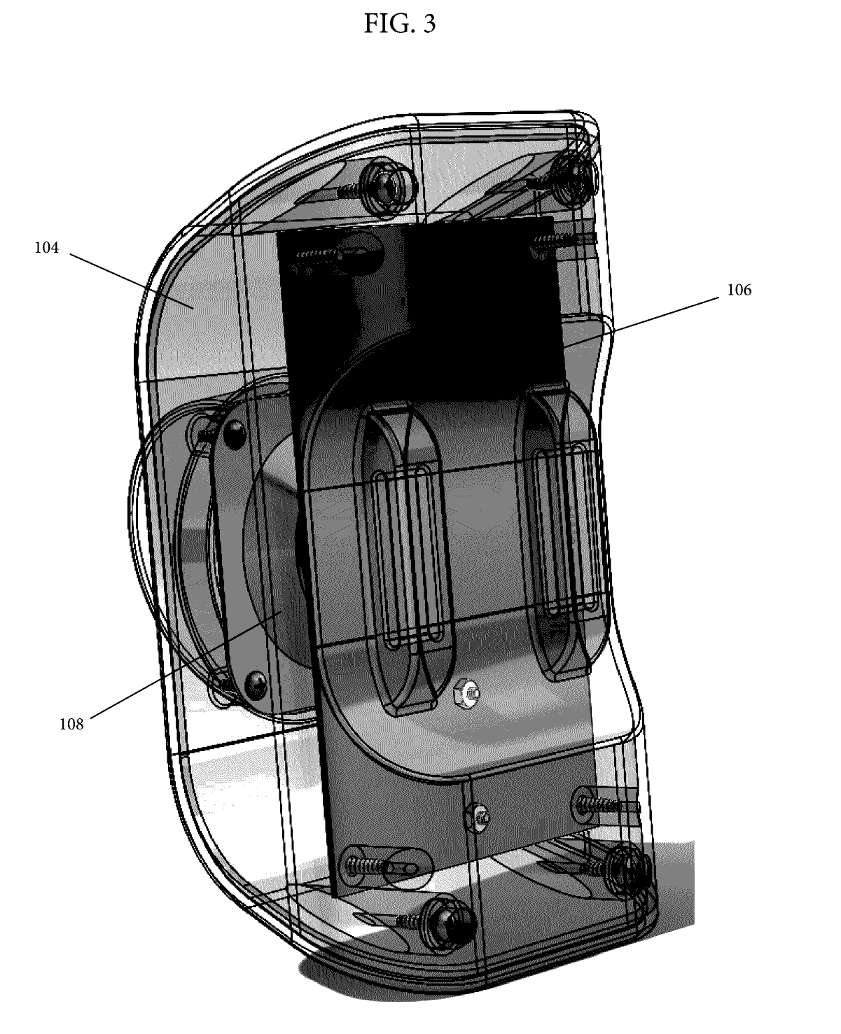

In some embodiments, the receiver/speaker houses an on/off switch 3104 (such as a slide switch), a power source 112, a receiver, an audio module, an audio amplifier, and a speaker 108. In some embodiments, the receiver/speaker can have an opening 114 or loop on the back of the receiver/speaker, as illustrated in FIGS. 3, 5, 6, and 33, so a strap or hook can be connected to the backside of the receiver/speaker. This enables the user to easily mount and dismount the receiver/speaker to a tree or other vertical surface. The strap can be made of nylon, can be one inch wide, and can be approximately 30 inches long with quick release clips and tightening ability.

The sound the speaker makes can be quiet or loud, wherein the volume of the quiet sound is about the same as a finger snap (i.e., 80-90 db) and the volume of the loud sound is about the same as a loud clap (i.e., around 107 db). However, the exact volume level of the sound may be determined by speaker type and size.

In some embodiments, the transmitter can trigger two or more speakers if the user has the need for multiple speakers or has multiple hunting stands, but does not want to keep track of more than one transmitter. In this case, receivers can operate on the same signal and the transmitter will operate all speakers within range simultaneously. To get receivers on the same signal, the user can change the default address by opening the receiver assembly and changing the switch code to match the transmitter's switch code. The transmitter and receiver/speaker may operate only in permitted radio frequency bands and are intended to be constructed in accordance with all FCC requirements.

The system can be sleek yet highly durable, rugged, and weather resistant, even in an outdoor environment with cold temperatures, wind, rain, dust, and snow. For example, the system can be highly water resistant and the receiver/speaker can be capable of staying on a tree or other vertical surface for an extended period of time. Additionally, the product can have a power source, such as a battery, and can operate outdoors under normal usage for up to 30 days before the power source need to be replaced or tended to. In some embodiments, the transmitter will use one or two batteries and the receiver/speaker will use two to four batteries. The power source, such as the batteries, can be replaceable or rechargeable.

In some embodiments, the transmitter will not consume power unless the button on the transmitter (the transmitter button) is pushed, and the receiver/speaker will not consume power unless the receiver/speaker is turned on. Further, the receiver/speaker may be resistant to inadvertent activation by radio or cell phone interference that would cause unwanted operation of the receiver/speaker.

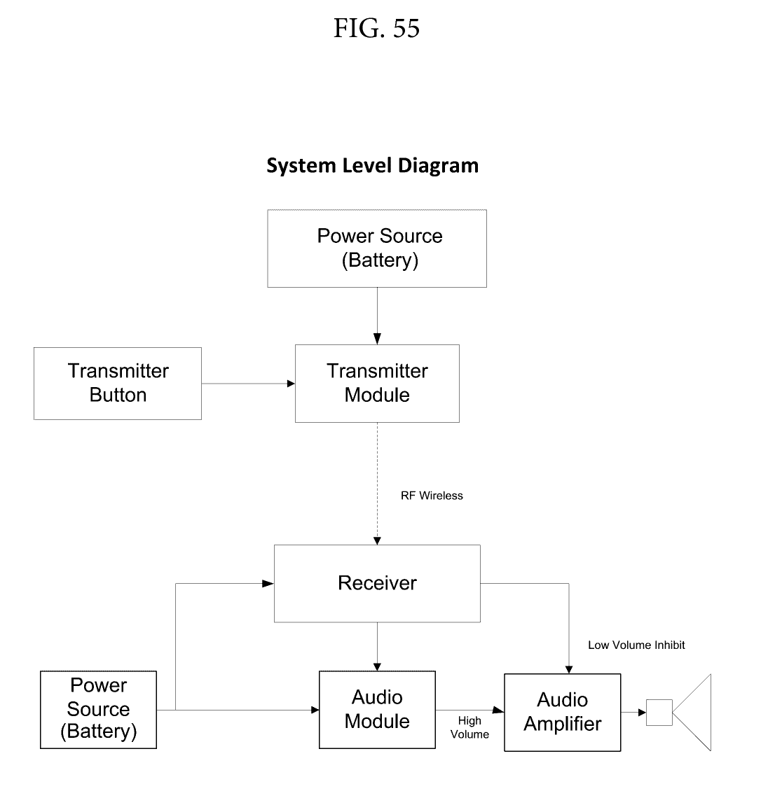

As described above and illustrated in FIG. 55, activation of the transmitter causes the receiver/speaker to produce a sound that will help distract and turn the attention of game animal from the hunter to the sound source. This is intended to allow the hunter a cleaner side view of the game animal and a cleaner and more humane kill shot. Deer, in particular, have acute senses, especially olfactory. Another noise in proximity to a hunter may be the only way to distract a deer from detection of the hunter.

The user can push the transmitter button, which will cause a battery-operated transmitter to send a wireless signal to a battery-operated receiver. The receiver will then send the signal to a battery-operated audio module and an audio amplifier and through a speaker to create either a low- or high-volume sound.

In some embodiments, the transmitter may communicate and send a data request to the receiver/speaker by using a radiofrequency (RF) based transmitter such as, but not limited to, Bluetooth or near field communication (NFC). Therefore, when the user presses the transmitter button, the transmitter may send a Bluetooth or NFC signal to the receiver/speaker, which then plays a pre-determined sound.

In some embodiments, the receiver/speaker may be activated by any remote signal transmission such as, but not limited to, infrared, wherein, when the transmitter button is pushed, a sensor on the receiver/speaker is tripped by the transmitter's IR signal and causes the speaker to play a pre-determined sound.

In some embodiments, the receiver/speaker may not require activation by the transmitter. For example, the receiver/speaker may be motion activated and may play a pre-determined sound when it senses any motion. This embodiment may help users remain completely still when game animal approaches.

In another embodiment, a user could activate the transmitter though a mobile application operable on a mobile device. In this embodiment, communication from the transmitter to the receiver/speaker could occur using a Bluetooth or NFC signal or through a modem with access to a wide area data network (on the receiver).

The method of transmission will vary depending on the desired range in that some methods (a) require line of sight with the receiver (IR-based), (b) are of insufficient strength to travel beyond specific ranges, such as Bluetooth, or (c) are subject to signal attenuation or interference based on local conditions (for example, terrain, density of wooded areas).

To control the system, the user can simply turn the receiver/speaker on using an on/off switch and can activate the transmitter using a single button. For example, to activate the transmitter and cause the receiver/speaker to emit a quiet sound, the user can press the transmitter button once. To cause the receiver/speaker to emit a loud sound, the user can press the transmitter button a second time within a set period of time, such as five seconds. In some embodiments, if the user pushes the transmitter button a third time within five seconds of the second time, the loud sound will be repeated. Therefore, after a set period of time has passed (ex: five seconds) since the transmitter button was pushed, the program will be restarted and the next button push will cause the receiver/speaker to emit, for example, a quiet sound.

In one example of a use case, a hunter may want to set up the system in a hunting area. The hunter can mount the receiver/speaker on a tree within forty to sixty yards of where the hunter will be waiting for game. The hunter can turn on the receiver/speaker using an on/off switch on the receiver/speaker. The hunter can then mount, or have previously mounted, the transmitter and button assembly onto the hunter's bow. To test the system, the hunter can press the transmitter button once and a quiet sound should be emitted by the receiver/speaker. The hunter can then press the transmitter button within five seconds of the initial press to cause the receiver/speaker to emit a loud sound. Every time the hunter presses the transmitter button, another loud sound will be emitted, provided that no more than five seconds elapse between each push. If the hunter waits longer than five seconds between pushes, the speaker will emit a quiet sound.

What is claimed is:

1. A system for distracting and better positioning game animal, the system comprising:
a transmitter comprised of:
a front and back housing,
a switch contained within the front and back transmitter housing,
a transmitter module contained within the front and back transmitter housing,
a transmitter button in communication with transmitter module,
a cable protruding from a top of the front transmitter housing,
a circuit board contained within the front and back transmitter housing, and
a power source contained within the front and back transmitter housing;
a receiver comprised of:
a front and back housing,
a circuit board contained within the front and back housing,
a speaker contained within the front and back receiver housing, wherein the front of the speaker aligns with a hole in the front receiver housing,
a speaker projection aligned with the speaker and attached to the front receiver housing,
a connection point on the back receiver housing for receiving a connector, and
a power source; and
a speaker housed with the front and back housing of the receiver, the speaker having a projection and a power source;
wherein:
a first activation of the transmitter button transmits a signal to the receiver;
the receiver produces a quiet sound upon the first activation;
a second activation of the transmitter button transmits a signal to the receiver; and
the receiver produces a loud sound upon the second activation.

2. The system of claim 1, wherein the transmitter button is connected to the front transmitter housing.

3. The system of claim 1, wherein the transmitter button is connected to the front transmitter housing via a cable wire attached to the cable.

4. The system of claim 1, wherein the connection point on the back receiver housing is a strap opening and the connector is a strap.
